(19) United States
(12) Patent Application Publication
(10) Pub. No.: US 2009/0000593 A1
(43) Pub. Date: Jan. 1, 2009

(54) Liquid injection apparatus for engines

(76) Inventors: Robert Walte John Parsons, Burin Bay Arm (CA); Felix Coady, Marystown (CA)

Correspondence Address: JAMES C. WRAY, 1493 CHAIN BRIDGE ROAD, SUITE 300, MCLEAN, VA, 22101, US

(21) Appl. No.: 12/082,678

(22) Filed: Apr. 11, 2008

(30) Foreign Application Priority Data
Apr. 11, 2007 (CA) 2,584,555

(51) Int. Cl. F02B 47/02

(52) U.S. Cl. 123/25 C; 123/572

(57) ABSTRACT

Liquid injection apparatus for an engine includes a T-junction unit having two arms and at least one leg, at least of one of the arms is connectable to an intake manifold of the engine. The other of the arms is connectable to a positive crank case ventilation valve, the leg being connectable to a liquid reservoir by way of a spray nozzle, operation of one or more pistons in the engine producing liquid flow into a combustion chamber of the engine. In some cases the liquid is water.

### BACKGROUND OF THE INVENTION

This invention relates to liquid injection apparatus for engines, for example internal combustion engines.

Water injection apparatus is well known for supplying moisture, in some form, to the intake of an engine, the object being to improve combustion, lessen the deposit of carbon, and to obtain other desirable effects, all tending to efficiency and economy.

### SUMMARY OF THE INVENTION

According to the present invention there is provided liquid injection apparatus for an engine comprising a T-junction unit having two arms and at least one leg, at least one of said arms being connectable to an intake manifold of said engine, the other of said arms being connectable to a positive crank case ventilation valve, said leg being connectable to a liquid reservoir by way of a spray nozzle, whereby, during use, operation of one or more pistons in said engine produces liquid flow from said reservoir through said spray nozzle into said intake manifold and into a combustion chamber of said engine. In some cases the liquid is water.

### BRIEF DESCRIPTION OF THE DRAWINGS

FIG. 1 is a diagram illustrating the components and arrangement of a liquid injection apparatus.

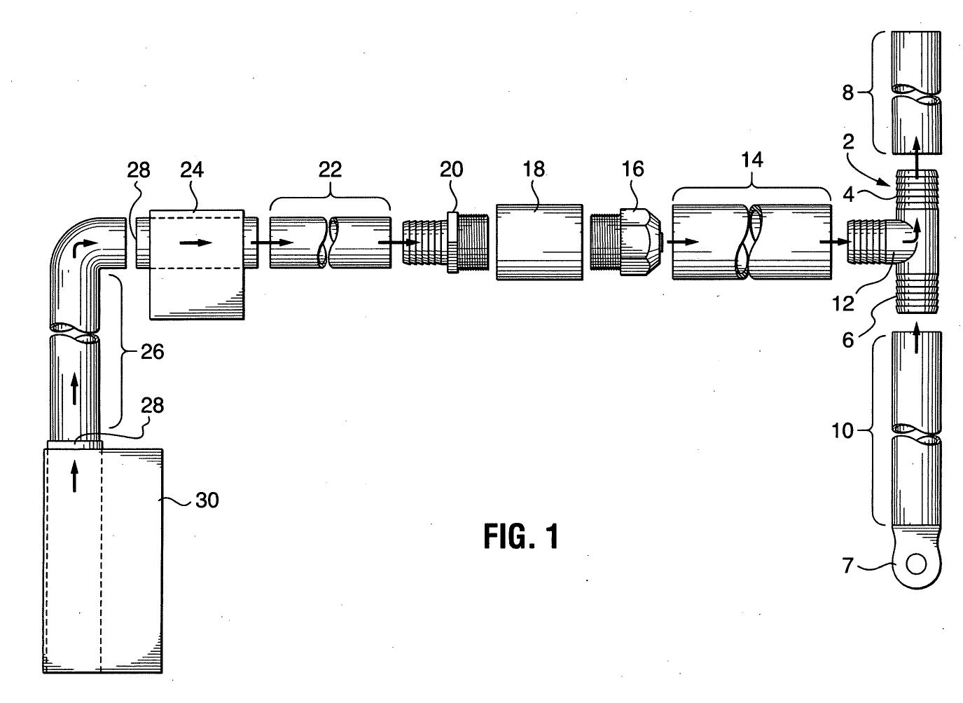

### DETAILED DESCRIPTION OF THE DRAWINGS

An embodiment of the invention will now be described, by way of example, with reference to the single FIGURE of the accompanying drawings in which a water injection apparatus for an internal combustion engine is diagrammatically illustrated. The FIGURE is opened up for explanatory purposes.

A brass T-junction unit 2 is provided with one of its arms 4 connected to the intake manifold of the engine (not shown) and the other arm 6 connected to the positive crankcase ventilation outlet valve 7. Connection is by way of lengths of ½ inch hose 8 and 10. The leg 12 of the T-junction unit 2 is connected to one end of a rubber pipe 14. The other end of the rubber pipe 14 has the injection tip 16 of a female close nipple unit 18 inserted into it to form a spray nozzle.

A female close nipple is a short piece of pipe with internal treads on both ends, acting as a connecting piece for the male barb and the injector tips.

The other end of unit 18 receives a male barb 20 to which is connected a length of ½ inch hose 22. A filter unit 24 is connected to the other end of hose 22 and a length of ½ suction hose 26 is connected to the input end 28 of filter 24. A male barb will be understood to be a knurled pipe which when a hose is inserted, seals and prevents the hose from withdrawing from the fitting.

Hose 26 is connected to the output 28 of a water reservoir tank 30.

In use, the units of the apparatus are connected together in the order shown in the drawings.

The hose 8 is connected to the intake manifold of the engine (not shown) and the reservoir 30 is provided with water. Activation of the unit occurs due to the pulsations of the piston (not shown) on its intake stroke. A suction is produced in hose 26 and this pulls water out of reservoir 30 and through hose 26, filter 24, hose 22, male barb 20, female close nipple 18, to the injection tip 16. The extension of the leg 12 comprising of water then proceeds through the rubber pipe 14, the T-junction unit 2, hose 8 and the intake manifold into the combustion chamber of the engine. It there combines with the gas/air charge to produce increased compression for the piston on the engine and thus more power. The amount of water is effectively metered due to the functioning of the apparatus.

The increased horsepower in the described embodiment is produced at a very low cost with a cleaner, cooler engine and a reduction in unwanted emissions.

As will be seen, the airflow from the crankcase to the intake manifold creates suction due to a venturi effect in the body of the T-unit 2. This causes water to be drawn from reservoir 30 through the injection tip 16 into the air flowing into the engine via the intake manifold. The air is thus moisturized.

The water in the intake air becomes steam in the combustion chamber and this provides cooler, more even combustion and an increase in compression. This, of course, translates into more power, reduced emissions and improved fuel economy.

As will be seen very little, if any, modification to the engine is required whether it is fuel-injected or carbureted and the embodiment can be used with any reciprocating engine, diesel or gasoline. When the water reservoir 30 is empty, the engine continues to function as it was formerly. When the reservoir 30 is refilled with water, the system again functions to improve overall performance.

Having thus described the invention in detail, it is understood that the forgoing description is not intended to limit the spirit and scope thereof. What is desired to be protected by Letters Patent is set forth in the appended claims.

The embodiments of the invention in which an exclusive property or privilege is claimed are defined as follow:

1. A liquid injection apparatus for an engine comprising a T-junction unit having two arms and at least one leg:
(a) at least of one of said arms being connectable to an intake manifold of said engine;
(b) the other of said arms being connectable to a positive crank case ventilation valve;
(c) said leg being connectable to a liquid reservoir by way of a spray nozzle in an extension of said leg;
(d) whereby, during use, operation of one or more pistons in said engine produces liquid flow from said reservoir through said spray nozzle into said intake manifold and into a combustion chamber of said engine.

2. A water injection apparatus for an engine comprising a T-junction unit having two arms and at least one leg:
(a) at least of one of said arms being connectable to an intake manifold of said engine;
(b) the other of said arms being connectable to a positive crank case ventilation valve;
(c) said leg being connectable to a water reservoir by way of a spray nozzle in an extension of said leg;
(d) whereby, during use, operation of one or more pistons in said engine produces water flow from said reservoir through said spray nozzle into said intake manifold and into a combustion chamber of said engine.

3. A water injection apparatus according to claim 2 wherein said spray nozzle has its input connected to the output of a female close nipple unit having a male barb unit at its other end to facilitate connection to one end of a length of a hose pipe whose other end is connected to the output of a water filter unit.

4. Water injection apparatus according to claim 3 wherein the input of said water filter unit is connected to the output of a water reservoir unit.
